(19) United States
(12) Patent Application Publication
(10) Pub. No.: US 2002/0158906 A1
(43) Pub. Date: Oct. 31, 2002

(54) Method of displaying correlation between biopolymer and probe

(76) Inventors: Junya Hashida, Kanagawa (JP); Takashi Kozuma, Kanagawa (JP); Iwao Yamashita, Kanagawa (JP); Takuro Tamura, Kanagawa (JP)

Correspondence Address: Pillsbury Winthrop LLP, Intellectual Property Group, 50 Fremont Street, P.O. Box 7880, San Francisco, CA, 94105, US

(21) Appl. No.: 10/077,648

(22) Filed: Feb. 14, 2002

(30) Foreign Application Priority Data
Mar. 29, 2001 (JP) 2001-96949

(51) Int. Cl. G09G 5/00

(52) U.S. Cl. 345/763

(57) ABSTRACT

Selection of probes is facilitated by effectuating intuitive and efficient discernment of entire constitutions of correlations between base sequences of biopolymers and base sequences of probes.

In selection of probes for use in bacterial identification, the base sequences of nucleic acids and the base sequences of probes are displayed with icons, and correlations among the base sequences of the nucleic acids and the base sequences of the probes are displayed with connective lines connecting the respective icons.

### PRIORITY INFORMATION

This application claims priority to Japanese Application Serial No. 2001-96949, filed Mar. 29, 2001.

### BACKGROUND OF THE INVENTION

1. Field of the Invention

The present invention relates to a method of displaying correlations between base sequences of biopolymers and base sequences of probes for the purpose of selecting an appropriate probe at preliminary stages of various biotechnological experiments involving both biopolymers and probes. Here, for example, the experiments includes a hybridization experiment using a so-called biochip with probes such as polynucleotide or oligonucleotide disposed on a glass slide and applying a biopolymer such as deoxyribonucleic acid of bacteria onto the biochip, or an experiment using samples other than biochips, such as beads. More specifically, the present invention relates to a method of displaying correlations in the case where base sequences of a plurality of biopolymers and base sequences of a plurality of probes establish correlations therein.

Various modes have been conventionally known as methods of displaying a correlation between a biopolymer such as a nucleic acid and a probe. However, a majority of those methods adopt a mode of displaying base sequences of coincident parts one-on-one when a base sequence of a probe and a part of a base sequence of a certain biopolymer coincide completely or partially with each other. FIG. 1 shows one example of such conventional methods. A part of a base sequence of Nucleic Acid 10 and a base sequence of Probe 11 therein coincide completely with each other, and those coincident bases are displayed with lines 12 connecting therebetween.

2. Problems to be Solved by the Invention

In the case where correlations exist between a plurality of nucleic acids and a plurality of probes, such plural correlations become hardly discernible according to the above method of displaying a correlation between a nucleic acid and a probe by connecting coincident bases with lines. If one of the probes is selected without sufficient discernment and an experiment is conducted by fixing the probe onto a biochip, such an experiment bears a risk of false results. For example, in the case where an experiment is conducted concerning bacteria extracted from a sample, if a user adapts a probe selected for identifying a bacterium 1 without knowing that a base sequence of the probe is actually very similar to a base sequence of another bacterium 2, then the user bears a risk of misidentifying the bacterium 2 extracted from the sample as the bacterium 1.

### SUMMARY OF THE INVENTION

The present invention has been made in consideration of the foregoing circumstance. An object of the present invention is to provide a display method that effectuates intuitive and efficient discernment of correlations between a plurality of biopolymers and a plurality of probes, whereby a user can readily select an optimum probe that the user needs.

The foregoing object of the present invention is achieved by displaying a plurality of biopolymers such as nucleic acids and a plurality of probes subject to correlations with icons, and by displaying such correlations with connective lines to be provided between the correlated icons while reflecting degrees of the correlations.

Specifically, a method of displaying correlations between biopolymers and probes according to the present invention is a method of displaying correlations between biopolymers and probes, in which the method displays a plurality of biopolymer icons severally designating distinct biopolymers, a plurality of probe icons severally designating distinct probes, and connective lines connecting the biopolymer icons with the probe icons. Here, each of the connective lines is displayed by a distinct display mode depending on a degree of a correlation between a base sequence of a biopolymer designated by one of the biopolymer icons and a base sequence of a probe designated by one of the probe icons.

The connective lines can adapt variations of line widths or colors depending on the degrees of the correlations.

In addition, it is preferable that the biopolymer icons and the probe icons are severally designed with different shapes and/or colors.

The method of displaying correlations between biopolymers and probes according to the present invention comprises the steps of: inputting data concerning the biopolymers, data concerning the probes and data concerning the correlations between the biopolymers and the probes; creating data for displaying the biopolymer icons indicating the biopolymers and the probe icons indicating the probes by analyzing the data concerning the biopolymers and the data concerning the probes; and creating data for the connective lines for connecting the biopolymer icons with the probe icons based on the data for displaying the biopolymer icons, the data for displaying the probe icons and the data concerning the correlations between the biopolymers and the probes. Here, the biopolymer icons and the probe icons are displayed as connected by the connective lines based on the respective data created.

In this event, display modes of the connective lines may vary depending on the degrees of the correlations between the base sequences of the biopolymers indicated by the biopolymer icons and the base sequences of the probes indicated by the probe icons. The display modes of the biopolymer icons or the probe icons may vary in accordance with characteristics of the biopolymers or probes, indicated by the respective icons.

Moreover, it is convenient if each of the biopolymer icons or the probe icons is rendered movable to a given position while keeping the connective line tied therewith indicating the correlation therebetween. It is preferable if detailed information associated with any particular icon or connective line is displayed upon designating a biopolymer icon, a probe icon or a connective line. Moreover, display of the connective line between one of the biopolymer icons and one of the probe icons may be omitted when the biopolymer icon and the probe icon are displayed overlapping each other or adjacently to each other.

Such a method of displaying correlations between biopolymers and probes is feasible by software.

According to the present invention, a plurality of base sequences of biopolymers and a plurality of base sequences of probes are displayed as icons, and each of the biopolymer icons and each of the probe icons are displayed as connected by a connective line that is made variable in its display mode depending on a correlation of two base sequences indicated by the respective icons, whereby intuitive and efficient discernment of entire constitutions of the correlations among the base sequences of the biopolymers and the base sequences of the probes becomes feasible and selection of optimum probes thereby becomes easier. Moreover, by undisplaying or omitting one, two or more icons, information on a correlation between objects or on the objects themselves can be readily obtained.

### BRIEF DESCRIPTION OF THE DRAWINGS

FIG. 1 is a view showing an example of a conventional method of displaying a correlation between a nucleic acid and a probe.

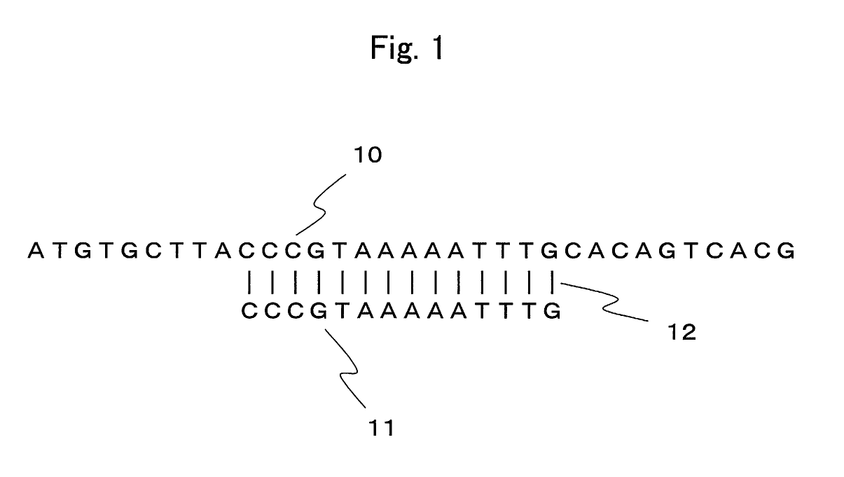

FIG. 2 is a view showing an example of hardware configuration of a system according to the present invention.

FIG. 3 is a schematic flowchart of processing for displaying a correlation diagram between a nucleic acid and a probe.

FIG. 4 is a view showing an example of nucleic acid data to be inputted.

FIG. 5 is a view showing an example of probe data to be inputted.

FIG. 6 is a view showing an example of correlation data between nucleic acids and probes to be inputted.

FIG. 7 is a schematic flowchart of processing for deciding display positions of icons.

FIG. 8 is a view showing contents of a table of nucleic acid icons.

FIG. 9 is a view showing contents of a table of probe icons.

FIG. 10 is a schematic flowchart of processing for creating correlation diagram data.

FIG. 11 is a view showing contents of a table of connective lines.

FIG. 12 is a schematic flowchart of processing for displaying a correlation diagram.

FIG. 13 is a view showing an example of displaying a correlation diagram (vertical cross reference).

FIG. 14 is a view showing another example of displaying a correlation diagram (horizontal cross reference).

FIG. 15 is a schematic flowchart of processing for moving icons.

FIG. 16 is a view showing an example of rearrangement of a correlation diagram by moving icons.

FIG. 17 is a view showing omission of display of a connective line.

FIG. 18 is a view showing an example of displaying detailed information associated with a nucleic acid icon.

FIG. 19 is a view showing an example of displaying detailed information associated with a probe icon.

FIG. 20 is a view showing an example of displaying detailed information associated with a connective line.

### DETAILED DESCRIPTION OF THE PREFERRED EMBODIMENT

Now, an embodiment of the present invention will be described in detail with reference to the accompanying drawings. Here, description will be made regarding a case, as one example, where biopolymers are nucleic acids of a bacterium.

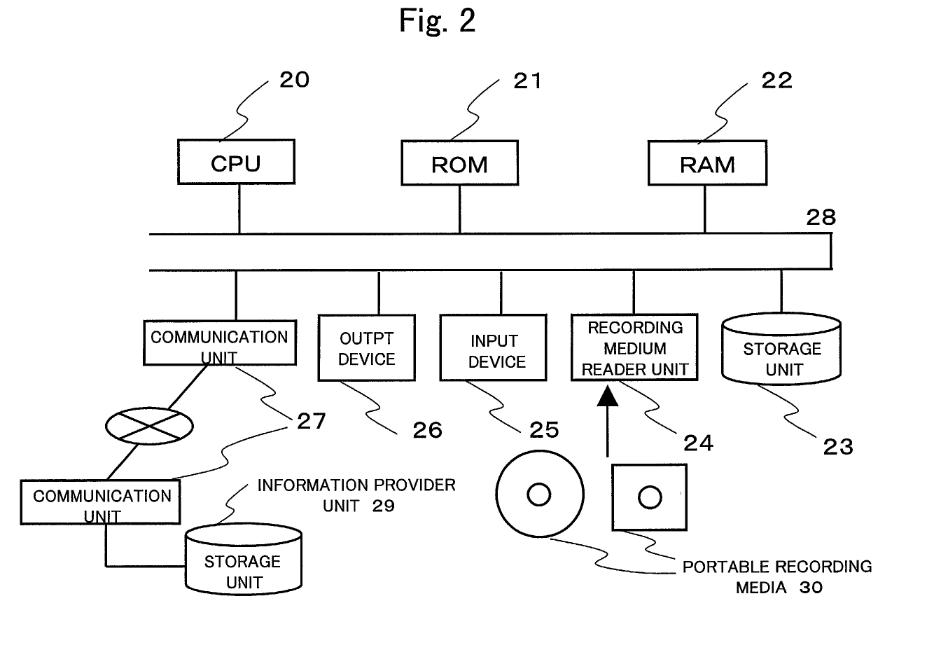

FIG. 2 is a view of a hardware configuration of an apparatus for realizing the embodiment. A method according to the present invention is applicable to software to be loaded on a personal computer or the like. As for requirements of hardware in the personal computer or the like, as illustrated in the drawing, conceivable is a configuration including a CPU 20, a ROM 21, a RAM 22, a communication unit 27, a storage unit 23, a recording medium reader unit 24, an input device 25, an output device 26 and the like, all of which are connected by a bus 28. Whereas the communication unit 27, an information provider unit 29, a portable recording medium 30 and the like are not always necessary, such inclusion will impart variety to the embodiment of the present invention.

The CPU 20 is provided for processing data based on a program for executing a method of the present invention. The program is unfolded as readable by the CPU 20, and is stored in the RAM 22 or the like. The ROM 21 stores BIOS and the like to be read by the CPU 20 at first when the apparatus in the drawing is booted up, in order to effectuate input by the input device 25 and output to the output device 26. By all means, the ROM 21 may store the program if the apparatus in the drawing is designed exclusively for execution of the method of the present invention.

As previously mentioned, the RAM 22 is provided for storing the program to enable the CPU to read and execute the program, and the RAM 22 serves as a work area. The program is stored in the storage unit 23 such as a hard disk, for example, and unfolded into the RAM 22 by the CPU 20 in accordance with an instruction by a user from the input device 25, and then executed in an unfolded state at the RAM 22. Here, the input device 25 is a keyboard, a mouse or the like, which is provided for passing instructions from the user of the apparatus in the drawing onto the apparatus of the embodiment. The output device 26 includes a display device, a printer, a plotter or the like, which outputs results of processing by the apparatus of the embodiment.

Usage of the program for realizing the method of the present invention is not limited only by storage in the storage unit 23, but a mode of execution is also feasible by way of: storing the program in the portable recording medium 30 such as a CD-ROM or a floppy disk; reading the program with the recording medium reader unit 24; and unfolding the program in the RAM 22. In such a mode of usage, since the program is stored in the portable recording medium 30 being transportable, the mode has advantages that the program can be readily distributed to many people, and that the method of the present invention becomes readily usable on the computer by installation into general-purpose personal computers generally having hardware environments as illustrated in the drawing.

Moreover, along with the popularization of computer communication today, another mode of usage is also feasible by way of: downloading the program or data for realizing the method of the present invention via a network; and executing the program on a local personal computer or the like. In other words, the program or the data for realizing the method of the present invention may be downloaded from the information provider unit 29 through the network by connection using the communication unit 27, and the program or the data can be used after being unfolded in the RAM 22.

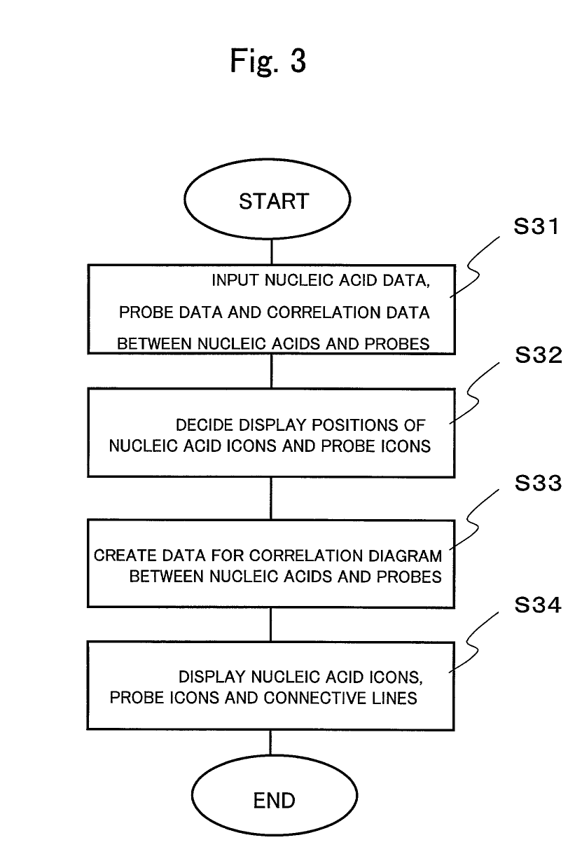

FIG. 3 is a flowchart showing an outline of processing of a program according to the embodiment to realize display of a correlation diagram between a nucleic acid and a probe. First, three kinds of data are inputted in Step S31, namely, nucleic acid data, probe data and correlation data between nucleic acids and probes. These data are prepared in advance either by hand work of the user or with another system or the like; therefore, the data may be inputted directly by the user with the keyboard, read out of the recording medium, or inputted from another system creating such data. The present invention is designed to display correlations between the nucleic acids and the probes by use of icons, in order to allow the user to select an optimum probe intuitively using the prepared data.

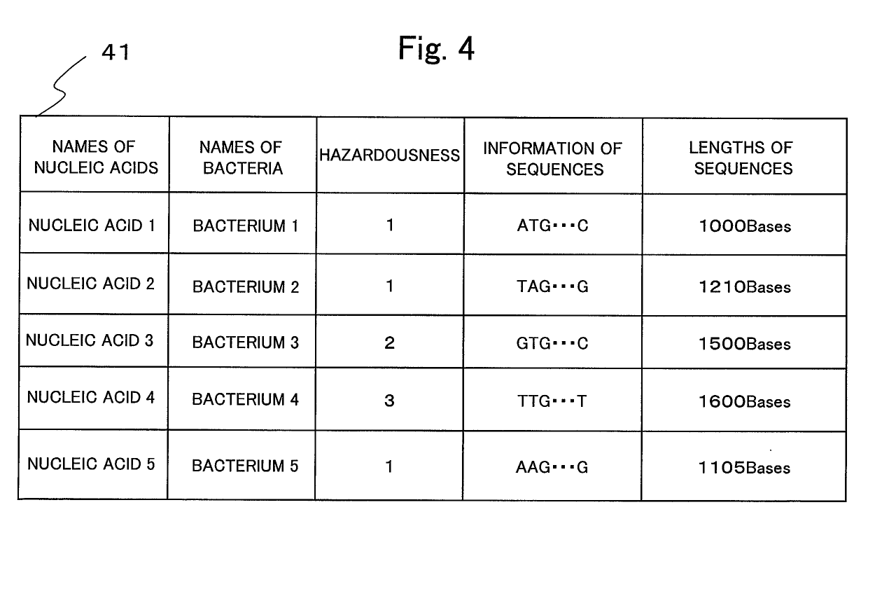

FIG. 4 is an example of the nucleic acid data to be inputted. The nucleic acid data 41 stores data of the nucleic acids for searching the optimum probe for identification in the form of sequences in the number of the nucleic acids. Information in each nucleic acid data record includes a name of a bacterium indicated by the nucleic acid, information concerning the bacterium (such as hazardousness of the bacterium), a base sequence thereof, a length of the base sequence, and the like.

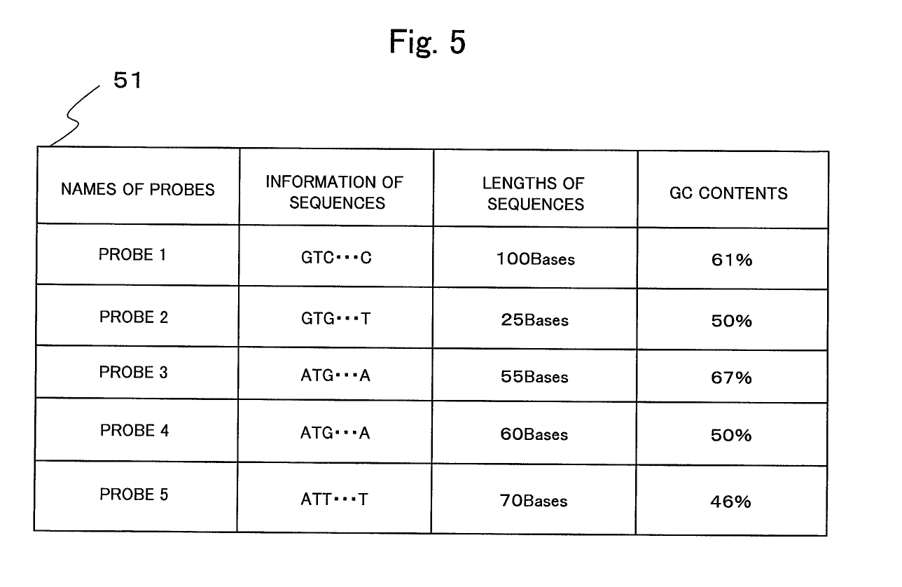

FIG. 5 is an example of the probe data to be inputted. The probe data 51 stores information on probes created from the respective nucleic acids in the nucleic acid data 41. Although only 5 probes are illustrated in FIG. 5, 10 to 20 probes are created from one nucleic acid in an initial stage of actual probe creation. Accordingly, the probe data for use may store the entire probes, or may store some probes extracted in advance as shown in this drawing. Information in each probe data record includes a base sequence of a probe, a length of the base sequence, the GC content thereof, and the like.

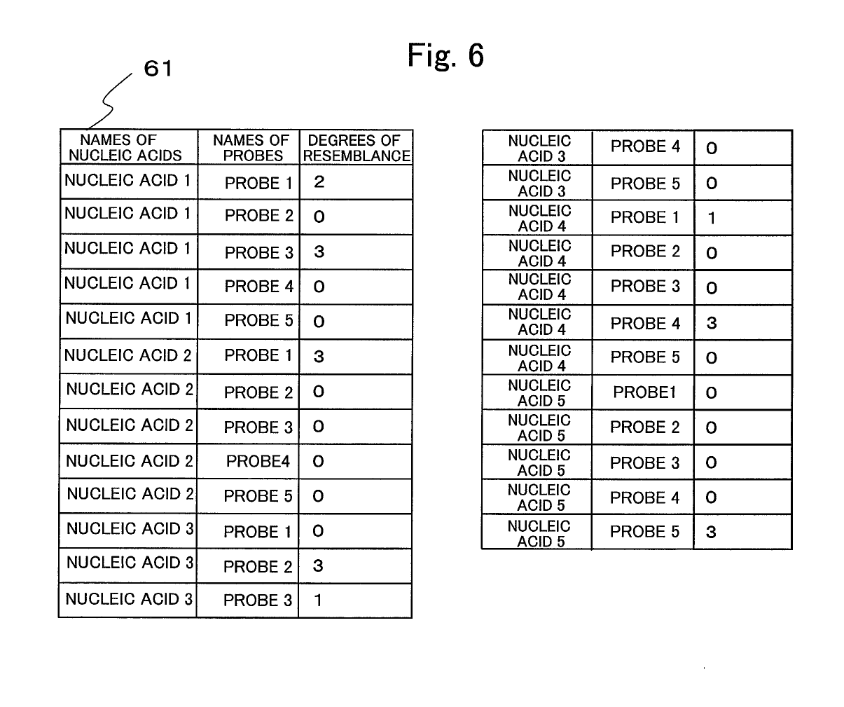

FIG. 6 is a view showing an example of correlation data between the nucleic acids and the probes. The correlation data 61 between the nucleic acids and the probes is a table of information on degrees of resemblance between the nucleic acids and the probes created in advance by analyzing the nucleic acid data 41 and the probe data 51. Here, indices of resemblance are used as the degrees of resemblance, for example, the indices of resemblance between sequences of the nucleic acids and sequences of the probes being referred to scores, resemblance and the like that are obtained in the event of executing homology searches.

Back to FIG. 3, after the nucleic acid data 41, the probe data 51 and the correlation data 61 between the nucleic acids and the probes are inputted, positions for displaying icons of the nucleic acids and the probes are decided in Step S32.

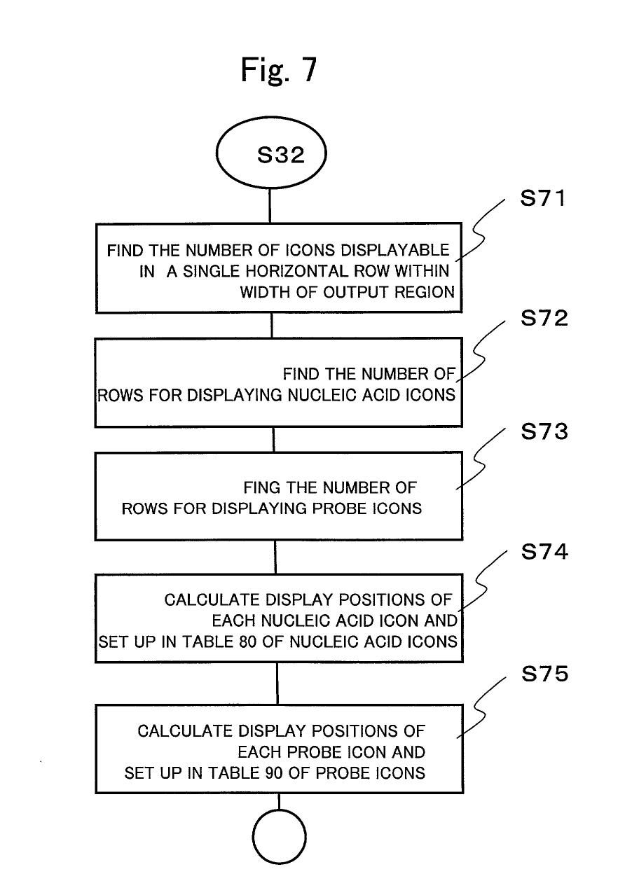

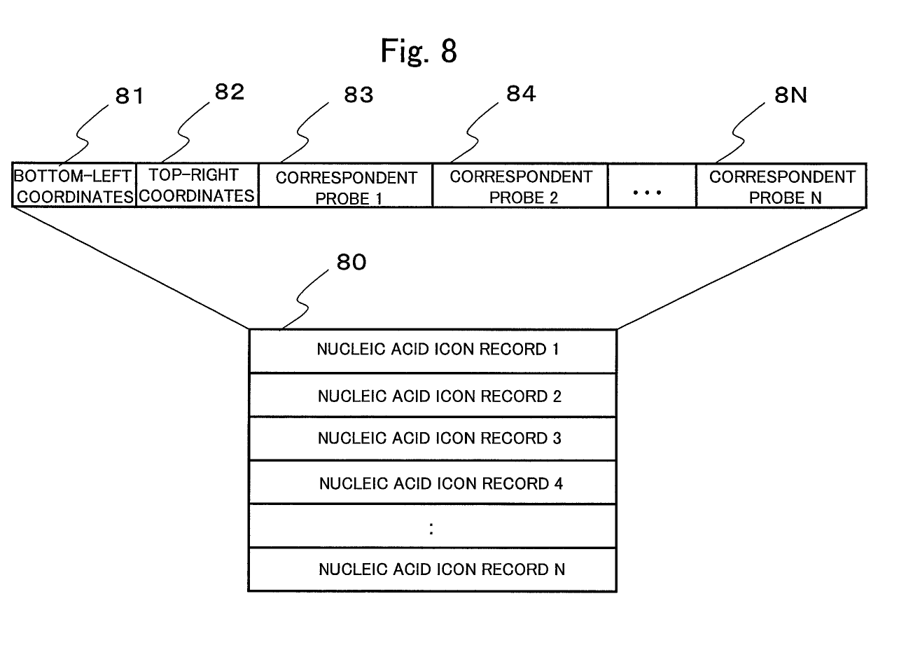

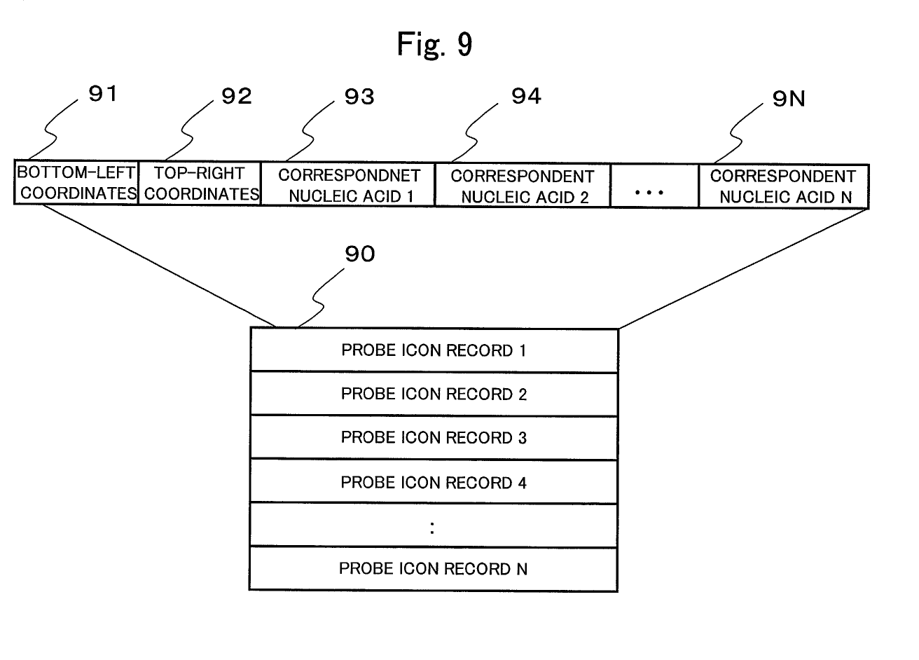

FIG. 7 is a flowchart exemplifying one mode of a method of deciding display positions of icons. First, in Step S71, a breadth of an output region is divided by a predetermined horizontal width necessary for displaying one icon, thus deciding the number of icons displayable in a single horizontal row. Next, in Step S72, the number of elements of the nucleic acid data 41 is divided by the number of icons in a single horizontal row, obtained in S71, thus deciding the number of rows for displaying nucleic acid icons. In Step S73, the number of the probe data is similarly divided by the number of icons in a single horizontal row, obtained in Step S71, thus deciding the number of rows for displaying probe icons. There may be a case where all the rows do not fall into a vertical space of the output region when the number of the rows is too many. In such a case, arrangement should be satisfactorily made by effectuating vertical scroll of the output region or the like. In the next Step S74, positions for displaying the nucleic acid icons are decided based on a preset start position for displaying the nucleic acid icons (such as offset from above the output region), vertical and horizontal lengths of one icon and lengths of pitches of rows and columns, the number of rows for the nucleic acid icons, which is obtained in S72, and the like. Here, the positions are decided on the assumption that the elements of the nucleic acid data 41 are serially displayed from the top left to the bottom left. This processing for the decision of the positions is feasible by basic geometric calculation; accordingly, detailed description thereto will be omitted. Moreover, in this event, a table 80 of the nucleic acid icons is created as shown in FIG. 8, and a position for each of the nucleic acid icons (which are bottom-left coordinates 81 and top-right coordinates 82 in FIG. 8) is set up. Each record on the table 80 of the nucleic acid icons corresponds serially to the elements of sequences of the inputted nucleic acid data 41 from the top. Similarly in Step S75, a start position for displaying the probe icons is set in a position below a predetermined distance from the bottom row of nucleic acid icon displays, and the positions for displaying the probe icons are decided based on vertical and horizontal lengths of one icon and lengths of pitches of rows and columns, the number of rows for the probe icons, which is obtained in S73, and the like. Here, the positions for displaying the probe icons are decided on the assumption that the elements of the probe data 51 are serially displayed from the top left to the bottom left. Moreover, in this event, a table 90 of the probe icons is created as shown in FIG. 9, and a position for each of the probe icons (which are bottom-left coordinates 91 and top-right coordinates 92 in FIG. 9) is set up. Each record on the table 90 of the probe icons also corresponds serially to the elements of sequences of the inputted probe data 51 from the top.

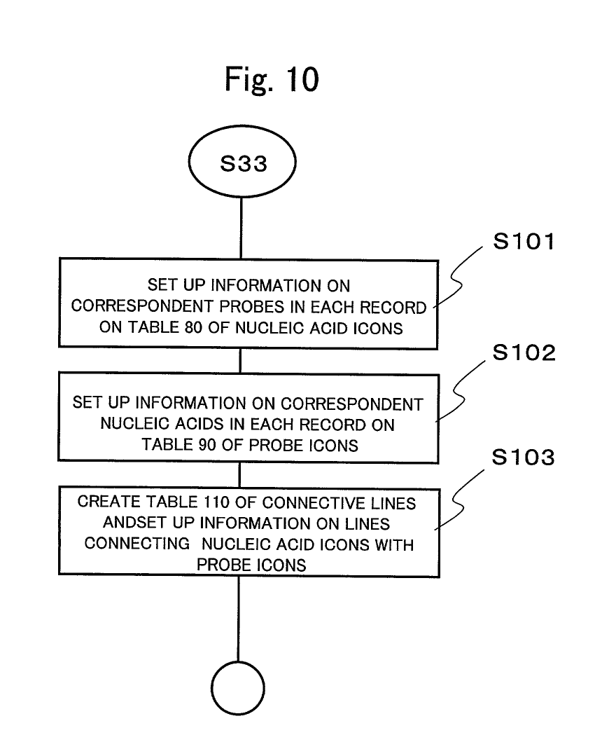

FIG. 10 is a flowchart showing an outline of data creation processing for the correlation diagram in Step S33 of FIG. 3.

First, in Step S101, the correlation data 61 between the nucleic acids and the probes is analyzed, and information (from 83 to 8N) on the probes corresponding to each of the nucleic acids is set up on the table 80 of the nucleic acid icons. The information sets up sequence element numbers of the probe data 51. For example, regarding the correlation data between the nucleic acids and the probes in FIG. 6, Probe 1 corresponds to Nucleic Acid 1 to begin with, and Probe 1 is the first element according to the probe data in FIG. 5. Accordingly, 1 is set up as information 83 of a correspondent Probe 1 of the first element (which corresponds to Nucleic Acid 1) on the table 80 of the nucleic acid icons. In this way, the information on the correspondent probes is set up on the table 80 of the nucleic acid icons by the number of the corresponding probes.

In the next Step S102, the correlation data 61 between the nucleic acids and the probes is similarly analyzed, and information (from 93 to 9N) on the nucleic acids corresponding to each of the probes is set up on the table 90 of the probe icons. The information sets up sequence element numbers of the nucleic acid data 41. For example, regarding the correlation data between the nucleic acids and the probes in FIG. 6, Nucleic Acid 1 corresponds to Probe 1 to begin with, and Nucleic Acid 1 is the first element according to the nucleic acid data in FIG. 4. Accordingly, 1 is set up as information 93 of a correspondent Nucleic Acid 1 of the first element (which corresponds to Probe 1) on the table of the probe icons. In this way, the information on the correspondent nucleic acids is set up on the table 90 of the probe icons by the number of the corresponding nucleic acids.

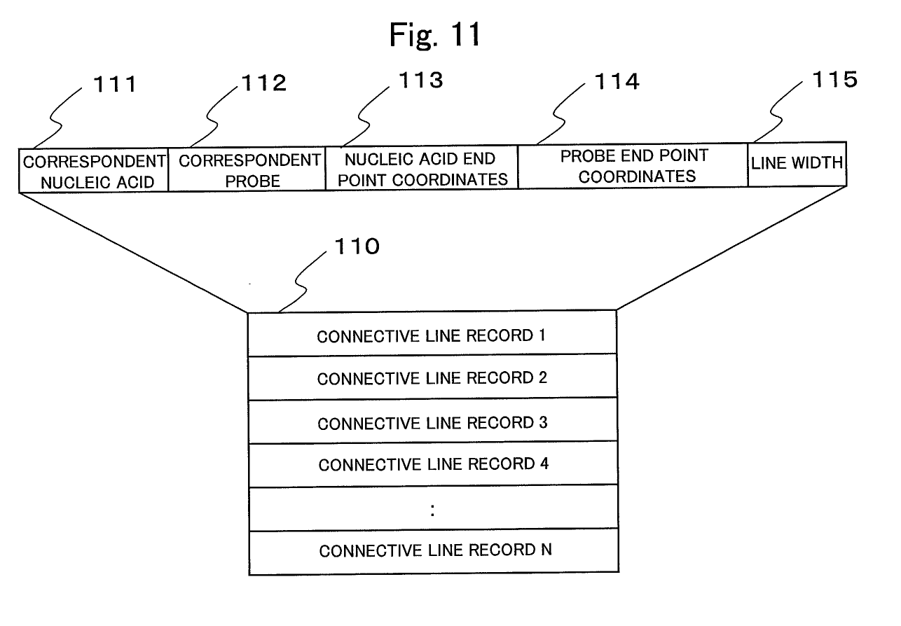

In the next Step S103, a table 110 of connective lines for storing information regarding lines connecting the nucleic acid icons and the probe icons is created as shown in FIG. 11. As Nucleic Acid 1 corresponds to Probe 1 in the correlation data 61 between the nucleic acids and the probes to begin with, the sequence element number 1 of Nucleic Acid 1 in the nucleic acid data 41 is set up as the correspondent Nucleic Acid 111 in the first sequence element record of the table 110 of the connective lines, and the sequence element number 1 of Probe 1 in the probe data 51 is set up as the correspondent Probe 112. Coordinates of end points of segments of the nucleic acid icon is set up as a nucleic acid end point 113. In the case where the nucleic acid icon is displayed above and the probe icon is displayed below, then coordinates for the midpoint on the lower side of the icon of Nucleic Acid 1 may be calculated from the bottom-left coordinates 81 and the top-right coordinates 82 on the table 80 of the nucleic acid icons. Similarly, coordinates of end points of segments of the probe icon is set up as a probe end point 114. In the case where the nucleic acid icon is displayed above and the probe icon is displayed below, then coordinates for the midpoint on the upper side of the icon of Probe 1 may be calculated from the bottom-left coordinates 91 and the top-right coordinates 92 on the table 90 of the probe icons.

A width of a line connecting the nucleic acid icon and the probe icon is set up as a line width 115. For example, a value of the degree of resemblance in the correlation data between the nucleic acids and the probes, shown in FIG. 6, may be simply set up as the line width. In this case, since the degree of resemblance between Nucleic Acid 1 and Probe 1 is 2, the value 2 is set up as the line width. Although the degree of resemblance is expressed by the line width in this embodiment, the degree of resemblance may be distinguished by other display attributes such as colors. Otherwise, when only information as to the correlations is required therein, the icons may be connected by uniform lines without distinction of the line widths based on the degrees of resemblance.

The elements of the table 80 of the nucleic acid icons, of the table 90 of the probe icons and of the table 110 of the connective lines are not limited to the modes described above, but the elements thereof may be added or subtracted as necessary. For example, the correspondent probe elements in the table 80 of the nucleic acid icons and the correspondent nucleic acid elements in the table 90 of the probe icons are not necessarily stored therein if the correlation data 61 between the nucleic acids and the probes is searched over when the need arises. Nevertheless, such arrangement may be time-consuming because search processing would take place quite frequently. Moreover, information regarding, for example, the display attributes including a color, a highlight or the like corresponding to hazardousness of a bacterium indicated by a base sequence may be also stored with respect to each icon on the table 80 of the nucleic acid icons or on the table 90 of the probe icons.

Back again to FIG. 3, after completion of the data creation processing for the correlation diagram in Step S33, the processing moves to processing for display of the correlation diagram in Step S34.

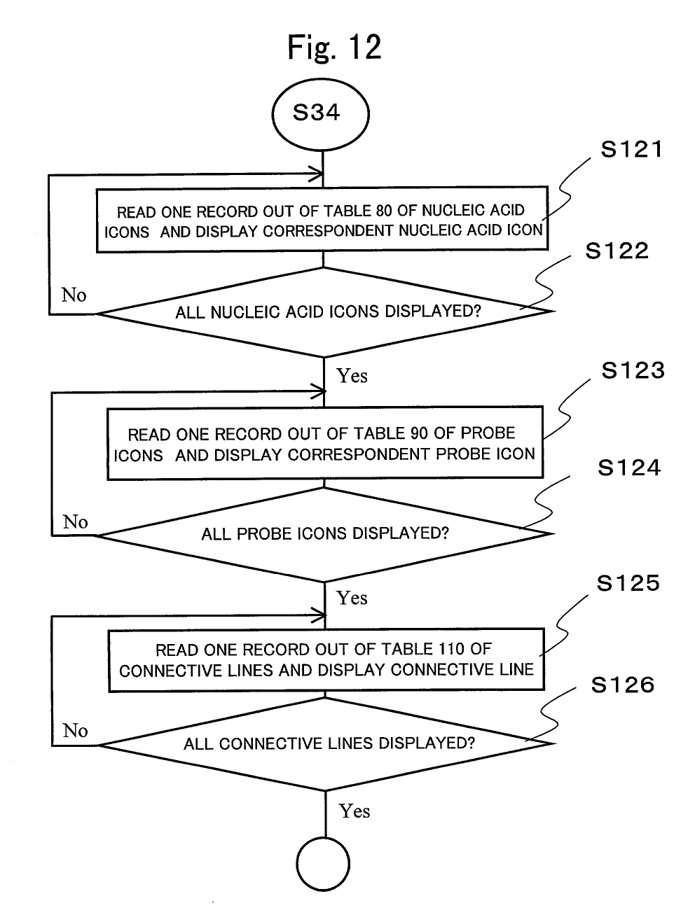

FIG. 12 is a flowchart showing one example of the processing for display of the correlation diagram in Step S34.

First, in Step S121, one record is retrieved from the table 80 of the nucleic acid icons and an icon is plotted based on the bottom-left coordinates 81 or the top-right coordinates 82 in the record. In this event, the name of the nucleic acid or a name of its corresponding bacterium and the like may be displayed in the icon with reference to the nucleic acid data 41, or a display factor (such as a color, display density or a highlight) of the icon may be changed to be displayed in accordance with hazardousness of the bacterium. Next, in Step S 122, judgment is made as whether all the records on the table 80 of the nucleic acid icons are processed, and the processing goes back to S121 for processing the next record when any unprocessed record is remaining. After all the records on the table 80 of the nucleic acid icons are processed, then in Step S123, one record is retrieved from the table 90 of the probe icons and an icon is plotted based on the bottom-left coordinates 91 or the top-right coordinates 92 in the record. In this event, the name of the probe and the like may be displayed in the icon with reference to the probe data 51. Next, in Step S124, judgment is made as whether all the records on the table 90 of the probe icons are processed, and the processing goes back to S123 for processing the next record when any unprocessed record is remaining. After completion of displaying all the probe icons, then the processing moves to Step S125, and one record is retrieved from the table 110 of the connective lines and a connective line is plotted based on information in the record on the nucleic acid end point 113, the probe end point 114 and the line width 115. Although the degree of resemblance is expressed by the line width in this embodiment, the degree of resemblance may be distinguished by other display factors such as colors. Alternatively, the degree of resemblance may be indicated by the number in the vicinity of the line. And then in Step 126, judgment is made as whether all the records on the table 110 of the connective lines are processed, and the processing goes back to S125 for processing the next record when any unprocessed record is remaining. Upon completion of displaying all the connective lines, the processing for creation of the correlation diagram is terminated, whereby the correlation diagram is finished.

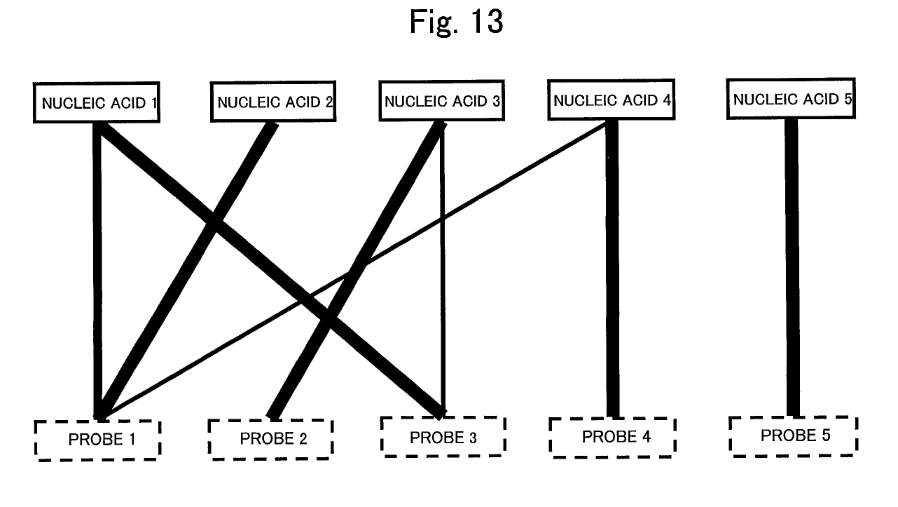

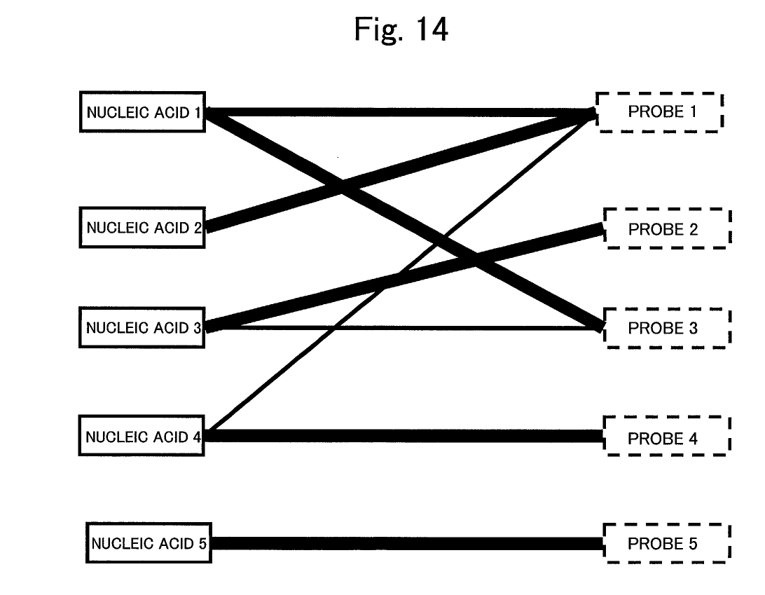

An example of the correlation diagram in which the nucleic acid icons are displayed above and the probe icons are displayed below is illustrated in FIG. 13, and another example of the correlation diagram in which the nucleic acid icons and the probe icons are displayed respectively on the left and on the right is illustrated in FIG. 14. However, modes of disposing those icons may take other forms.

Now, contents of display in the correlation diagrams of FIG. 13 and FIG. 14 will be described with reference to the nucleic acid data 41, the probe data 51 and the correlation data 61 between the nucleic acids and the probes. 5 nucleic acid icons and 5 probe icons are displayed therein, as equivalent to the number of the inputted nucleic acids and the inputted probes. With reference to the correlation data between the nucleic acids and the probes, the probes having the degrees of resemblance other than 0 with Nucleic Acid 1 are Probe 1 and Probe 3. As the degree of resemblance of Nucleic Acid 1 with Probe 1 is 2, Nucleic Acid 1 and Probe 1 are connected by a relatively thicker line. And as the degree of resemblance of Nucleic Acid 1 with Probe 3 is 3, Nucleic Acid 1 and Probe 3 are connected by an even thicker line. Since the degrees of resemblance of Nucleic Acid 1 respectively with Probe 2, Probe 4 and Probe 5 are 0, connective lines are not displayed therebetween. Other nucleic acids are connected with the probes according to the same rule. For example, Nucleic Acid 4 is connected with Probe 1 by the thinnest line because the degree of resemblance therebetween is 1, and Nucleic Acid 4 is connected with Probe 4 with the degree of resemblance at 4, by a line as thick as the line connecting Nucleic Acid 1 with Probe 3.

With reference to the correlation diagram, the user, for example, can understand that Probe 5 should be used for identifying Nucleic Acid 5. Moreover, Probe 3 of the highest degree of resemblance should be first used for identifying Nucleic Acid 1. However, it is intuitively understood that, since Probe 3 also has resemblance to Nucleic Acid 3, it is necessary to additionally use Probe 1 for identifying Nucleic Acid 1 as Probe 1 has the degree of resemblance of 0 with Nucleic Acid 3. Moreover, when the user wishes to identify any one of Nucleic Acid 1, Nucleic Acid 2 and Nucleic Acid 4 initially, then it is understood that Probe 1 should be used.

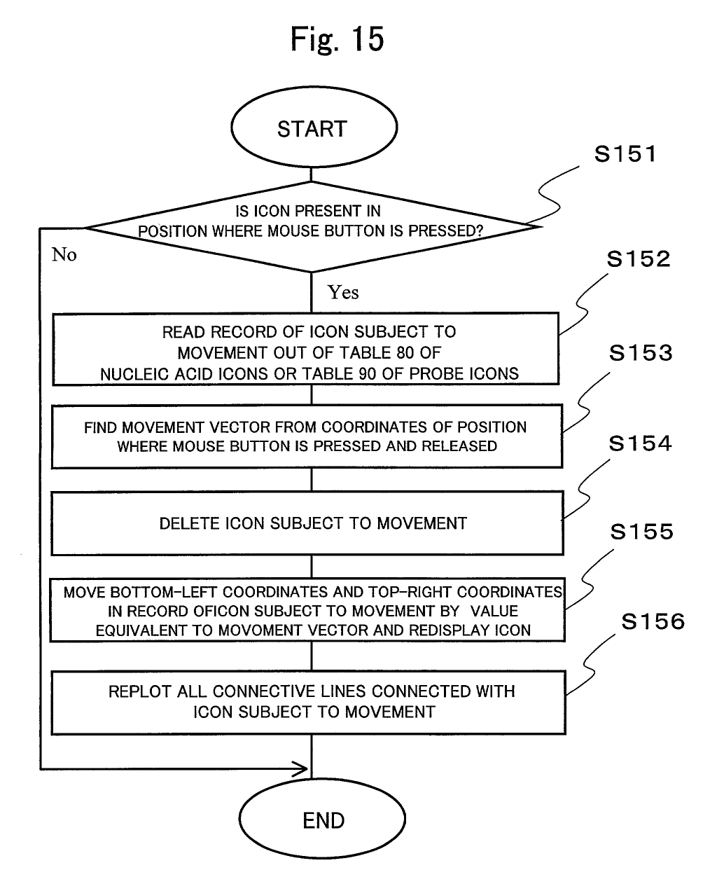

FIG. 15 is a schematic flowchart showing one example of processing for moving icons. Here, description will be made for an example of moving the icons by designating the icons with a mouse. First, in Step S151, it is checked whether any icon is present in a position where a mouse button is pressed. Such judgment is feasible by using positions of mouse coordinates, the bottom-left coordinates and the top-right coordinates of each icon in the table 80 of the nucleic acid icons and the table 90 of the probe icons. When there is no icon in the position where the mouse button is pressed, the processing is terminated. When there is an icon in the position where the mouse button is pressed, then the processing moves to Step S152, and a record concerning the icon subject to movement is retrieved from the table 80 of the nucleic acid icons or from the table 90 of the probe icons. Next, in Step S153, a movement vector is found out based on the coordinates where the mouse button is pressed and coordinates where the mouse button is released. Then in Step S154, the icon subject to movement is deleted. Then in Step S155, the icon is replotted at its destination. To be more precise, a value of the movement vector found in S153 is added to the bottom-left coordinates and to the top-right coordinates in the record of the icon subject to movement, and then the icon is displayed in that position. Lastly in S156, a connective line is replotted. To be more precise, the records of the connective lines connected with the icon subject to movement are first searched over the table 110 of the connective lines, and the value of the movement vector found in S153 is added to coordinates of the end point of the subject of movement. Thereafter, the original connective line is deleted, and then the connective line is plotted by use of new end point data. It is conceivable, however, that, in this mode the icon and the connective line may intercross each other in the case where a positional relation or the like between the corresponding icons is reversed. Accordingly, end points for plotting an optimum connective line may be recalculated based on reference to the bottom-left coordinates and the top-right coordinates of the two icons to be connected by use of the respective tables of the icons. Such processing of replotting the connective lines will be iterated until replotting of all the connective lines connected with the moved icons is completed.

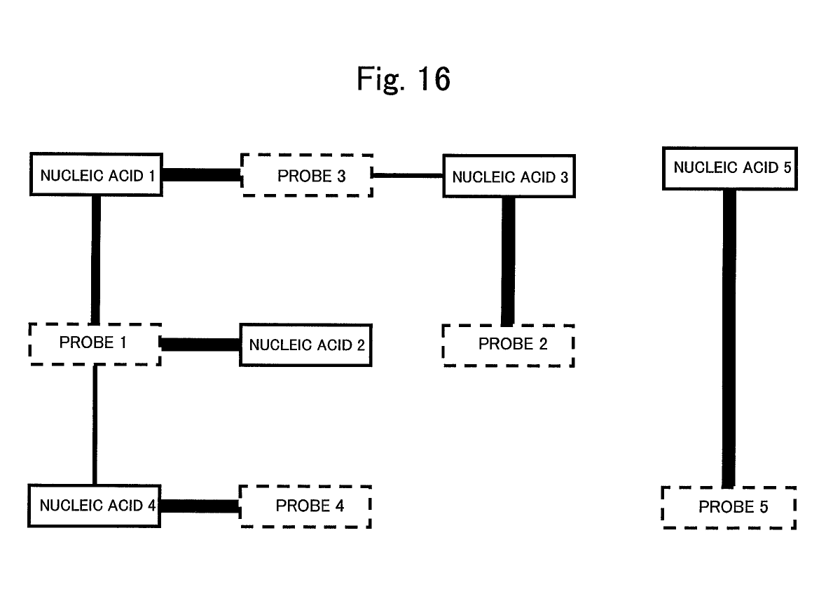

FIG. 16 is a rearrangement of the correlation diagram shown in FIG. 13 by the processing of moving icons. In this way, it is feasible to rearrange the positional relations between the icons so that the positional relations therebetween become discernible.

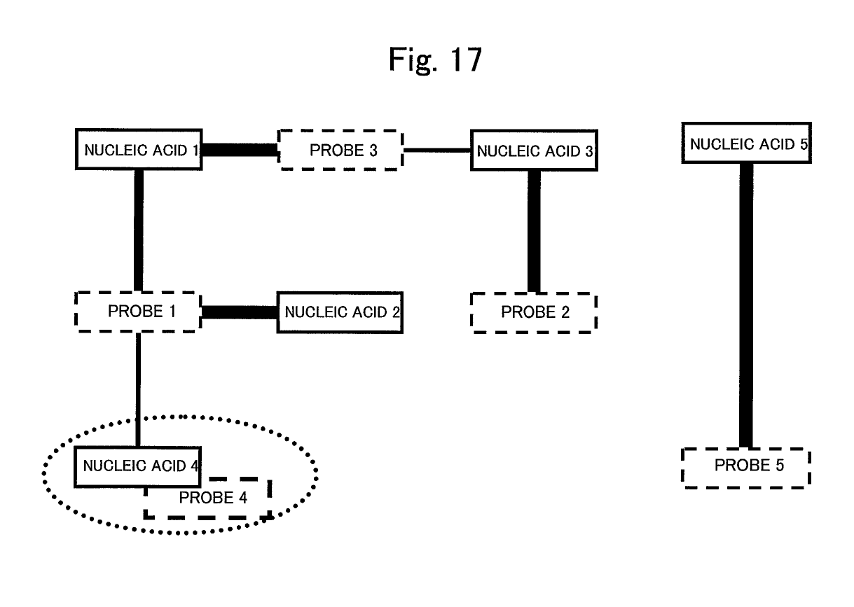

FIG. 17 is a view showing an example of omitting display of a connective line. Since Nucleic Acid 4 is the only nucleic acid that connects with Probe 4, complexity of a screen can be reduced by adopting overlapping display as illustrated instead of displaying the connective line. This drawing is an example of omitting display of a connective line by designating a certain probe (here Probe 4). As the concrete processing, it may be arranged in the following manner that: when an instruction is made by a double-click or the like on a certain probe to omit display of its connective line, the record relevant to the probe in the table 90 of the probe icons is checked; the processing for moving the probe icon is carried out in the case where there is just one correspondent nucleic acid thereto; the connective line is deleted; and a flag is set up on the record in the table 110 of the connective lines, the record concerning the line connecting the both icons, which indicates a change to overlapping display. For example, information indicating omission of display of the connective line may be set up instead of the coordinate values of the nucleic acid end point 113 and the probe end point 114 of the relevant record.

Moreover, it is also feasible to designate omission of display of the connective lines before creating the correlation diagram so that display of the connective lines are omitted with respect to all the probes having just one correspondent nucleic acid. In this case, information may be set up with reference to the table 90 of the probe icons, in case of the probes having just one correspondent nucleic acid, so as to indicate omission of display of the connective line with respect to the coordinate values of the nucleic acid end points 113 and the probe end points 114 in the records storing all the correspondent probes in the table 110 of the connective lines. There, the positions of the probe icons subject to movement may be decided based on the bottom-left coordinate values 81 and the top-right coordinate values 82 of the correspondent nucleic acids in the table 80 of the nucleic acid icons, and the values thus decided may be set up as the bottom-left coordinate values 91 and the top-right coordinate values 92 on the table 90 of the probe icons.

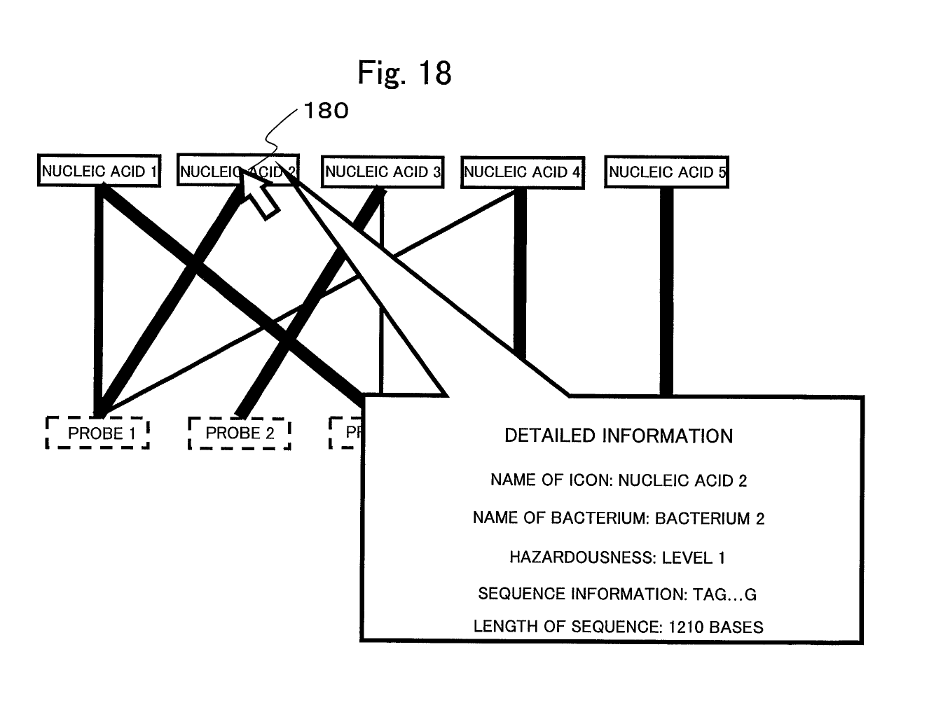

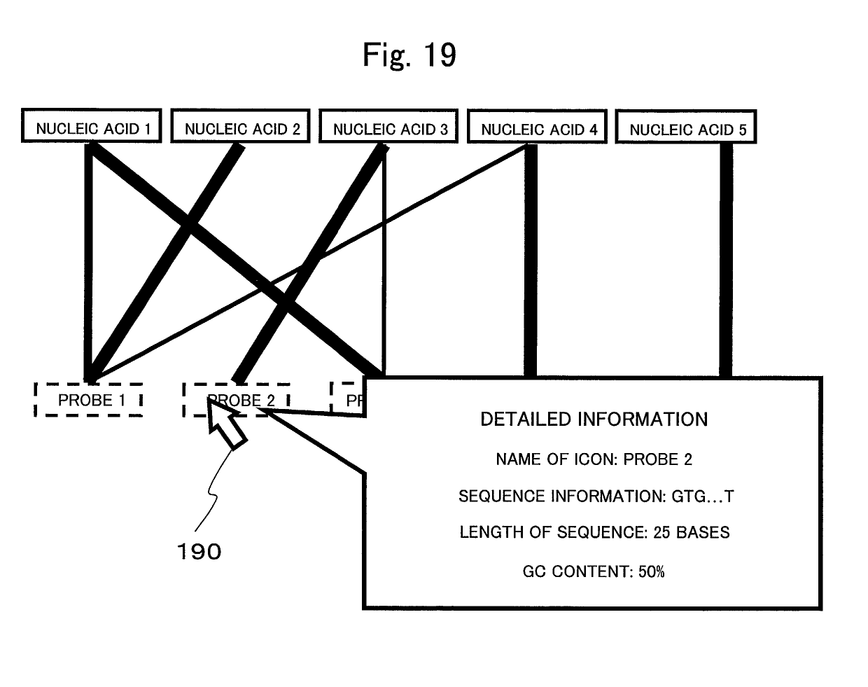

FIG. 18 and FIG. 19 are examples of displaying detailed information of icons, wherein FIG. 18 is a case of designating a nucleic acid icon and FIG. 19 is a case of designating a probe icon. For example, when a mouse cursor (denoted by 180 in FIG. 18 and by 190 in FIG. 19) remains unmoved in a certain area for five seconds or longer, judgment is made as whether there is an icon in that position by use of information regarding icon regions (the bottom-left coordinate values and the top-right coordinate values) on the table 80 of the nucleic acid icons and the table 90 of the probe icons. When an icon is present, detailed data corresponding to the icon may be searched over the nucleic acid data 41 or the probe data 51 and displayed. In the case where the mouse cursor is located in a position where two icons overlap due to omission of display of the connective line, arrangement may be made for allowing the user to switch display of the detailed data regarding either of the icons by pressing a specified key on the keyboard or the like.

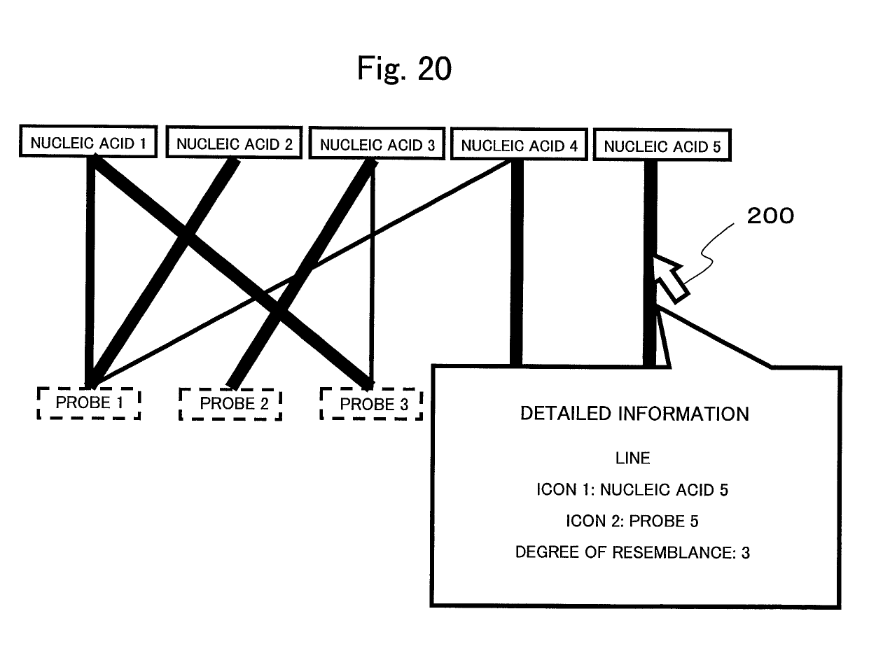

FIG. 20 is an example of designating a connective line to display detailed information thereof. Similarly to the case of displaying the detailed information of the icons, when a mouse cursor 200 remains unmoved in a certain area for 5 seconds or longer, for example, then judgment is made as whether the mouse cursor is located on any of the lines composed of the nucleic acid end points 113 and the probe end points 114 of the respective records in the table 110 of the connective lines. When the mouse cursor is located on a connective line, detailed data corresponding to the connective line stored in the table 110 of the connective lines may be displayed. In the case where the mouse cursor is located on an intersecting point of the lines, then arrangement may be made for allowing the user to switch the connective line subject to display of the detailed data by pressing a specified key on the keyboard or the like.

Also in the case where the icon and the connective lines overlap each other, arrangement may be made for allowing the user to switch display of the detailed data either on the icon or on the connective line to be displayed by pressing a specified key on the keyboard or the like.

By provision of the above-described functions for displaying the detailed data, the user can learn the detailed data of objects indicated only as the icons or the connective lines.

Moreover, by creating the above-described table 80 of the nucleic acid icons, the table 90 of the probe icons and the table 110 of the connective lines, the following function can be also realized.

For example, conceivable is a function to designate a certain nucleic acid icon in order to highlight all the probe icons connected therewith. This function is effective in a case where there are so many icons that the correspondence among the icons is indiscernible at a glance. To be more precise, the correspondent probes are searched over the record in the table 80 of the nucleic acid icons corresponding to the designated nucleic acid icon, and the positions (91 and 92) of the correspondent probe icons in the table 90 of the probe icons are further referred, whereby those icons may be replotted by highlighting. As for the method of highlighting, highlighted colors, blinks or the like may be used.

Moreover, on the contrary to the foregoing, conceivable is a function to designate a certain probe icon in order to highlight all the nucleic acid icons connected therewith. This function is also effective in the case where there are so many icons that the correspondence among the icons is indiscernible at a glance. To be more precise, the correspondent nucleic acids are searched over the record in the table 90 of the probe icons corresponding to the designated probe icon, and the positions (81 and 82) of the correspondent nucleic acid icons in the table 80 of the nucleic acid icons are further referred, whereby those icons may be replotted by highlighting. As for the method of highlighting, highlighted colors, blinks or the like may be used as similarly to the above.

As described above, according to the present invention, a user can intuitively discern correlations between a plurality of biopolymers and probes by creating a correlation diagram between the biopolymers and the probes by use of icons and connective lines, whereby selection of probes is facilitated.

What is claimed is:

1. A method of displaying correlations between biopolymers and probes,
wherein the method displays:
a plurality of biopolymer icons severally designating distinct biopolymers;
a plurality of probe icons severally designating distinct probes, and
connective lines connecting the biopolymer icons with the probe icons, and each of the connective lines is displayed by a distinct display mode depending on a degree of a correlation between a base sequence of a biopolymer designated by one of the biopolymer icons and a base sequence of a probe designated by one of the probe icons.

2. The method of displaying correlations between biopolymers and probes according to claim 1, wherein the connective lines have variations in any of line widths and colors depending on the degree of the correlation.

3. The method of displaying correlations between biopolymers and probes according to claim 1, wherein the biopolymer icons and the probe icons are severally designed with different variations in at least any of shapes and colors.

4. A method of displaying correlations between biopolymers and probes, comprising the steps of:
inputting data concerning biopolymers, data concerning probes and data concerning correlations between the biopolymers and the probes;
creating data for displaying biopolymer icons indicating the biopolymers and probe icons indicating the probes by analyzing the data concerning the biopolymers and the data concerning the probes; and
creating data for connective lines connecting the biopolymer icons with the probe icons based on the data for displaying the biopolymer icons, the data for displaying the probe icons and the data concerning the correlations between the biopolymers and the probes,
wherein the biopolymer icons and the probe icons are displayed as connected by the connective lines based on all the respective data created.

5. The method of displaying correlations between biopolymers and probes according to claim 4, wherein display modes of the connective lines vary depending on degrees of the correlations between base sequences of the biopolymers indicated by the biopolymer icons and base sequences of the probes indicated by the probe icons.

6. The method of displaying correlations between biopolymers and probes according to claim 1, wherein display modes of any of the biopolymer icons and the probe icons vary in accordance with characteristics of the respective biopolymers and probes indicated by the icons.

7. The method of displaying correlations between biopolymers and probes according to claim 1, wherein any one of the biopolymer icon and the probe icon is rendered movable to a given position while keeping the connective line tied therewith, indicating the correlation therebetween.

8. The method of displaying correlations between biopolymers and probes according to claim 1, wherein detailed information associated with any one of the biopolymer icons, the probe icons and the connective lines is displayed when such one of the biopolymer icons, the probe icons and the connective lines is designated.

9. The method of displaying correlations between biopolymers and probes according to claim 1, wherein display of the connective line between one of the biopolymer icons and one of the probe icons may be omitted in any one of a case where the biopolymer icon and the probe icon are displayed overlapping each other and a case where the biopolymer icon and the probe icon are displayed adjacently to each other.

10. Software for realizing the method of displaying correlations between biopolymers and probes according to claim 1.

11. The method of displaying correlations between biopolymers and probes according to claim 4, wherein display modes of any of the biopolymer icons and the probe icons vary in accordance with characteristics of the respective biopolymers and probes indicated by the icons.

12. The method of displaying correlations between biopolymers and probes according to claim 4, wherein any one of the biopolymer icon and the probe icon is rendered movable to a given position while keeping the connective line tied therewith, indicating the correlation therebetween.

13. The method of displaying correlations between biopolymers and probes according to claim 4, wherein detailed information associated with any one of the biopolymer icons, the probe icons and the connective lines is displayed when such one of the biopolymer icons, the probe icons and the connective lines is designated.

14. The method of displaying correlations between biopolymers and probes according to claim 4, wherein display of the connective line between one of the biopolymer icons and one of the probe icons may be omitted in any one of a case where the biopolymer icon and the probe icon are displayed overlapping each other and a case where the biopolymer icon and the probe icon are displayed adjacently to each other.

15. Software for realizing the method of displaying correlations between biopolymers and probes according to claim 4.
